(19) United States
(12) Patent Application Publication
(10) Pub. No.: US 2012/0314234 A1
(43) Pub. Date: Dec. 13, 2012

(54) IMAGE PROCESSING APPARATUS, IMAGE PRINTING APPARATUS AND IMAGE PROCESSING METHOD

(75) Inventor: Shinichi Miyazaki, Kawasaki-shi (JP)

(73) Assignee: CANON KABUSHIKI KAISHA, Tokyo (JP)

(21) Appl. No.: 13/484,634

(22) Filed: May 31, 2012

(30) Foreign Application Priority Data
Jun. 7, 2011 (JP) 2011-127232

(51) Int. Cl. G06F 15/00

(52) U.S. Cl. 358/1.9

(57) ABSTRACT

An image processing apparatus, image printing apparatus and image processing method are provided that can output an image that fulfills both of sharpness and robustness by multi-pass printing regardless of the image. For this purpose, in preforming multi-pass printing, a distribution coefficient for distributing density data of each pixel to multiple printing scans varies depending on attribute information of the each pixel. For a pixel whose attribute information indicates importance on robustness, a bias of distribution coefficients for multiple scans are made small; and for a pixel whose attribute information indicates importance on sharpness, a bias of distribution coefficients for multiple printing scans is made large.

### BACKGROUND OF THE INVENTION

1. Field of the Invention

The present invention relates to an image processing apparatus, image printing apparatus and image processing method, more specifically, an image processing method to generate data for each scan of multi-pass printing in a serial-type printing apparatus.

2. Description of the Related Art

A serial-type inkjet printing apparatus often employs multi-pass printing. In multi-pass printing, a print head prints an image in a stepwise fashion in such a way that all dots that can be printed in one main scan are distributed into multiple scans between which a conveying operation is performed. In this case, in a conventional multi-pass printing, after binary data to be printed is generated, the binary data is divided with the use of mask patterns that have a complementary relationship to one another thereby to generate dot groups, each corresponding to each printing scan. The dot groups generated in this way, each corresponding to each printing scan, have an exclusive and complementary relationship to one another. Therefore, by performing such a multi-pass printing, even if there are variations of ejection characteristics among a plurality of printing elements, dots printed by each of the printing elements do not continue in a scan direction, but the variations are distributed to multiple printing scans. That is, a stripe and unevenness on an image due to variations of ejection characteristic become less visible.

However, in employing the above multi-pass printing, if a printing position shift occurs in units of printing scans, density unevenness may be recognized. If a printing position shift occurs in units of printing scans, a shift occurs between groups of dots, causing a complementary relationship between the groups of dots to collapse. As a result, in some regions, two dots to be printed at adjacent positions overlap to each other, reducing a coverage of dots relative to a print medium. That is, only a region where a printing position shift occurs has a lower density than that of other regions and density unevenness may be recognized. Such a printing position shift in units of scans is caused by, for example, change of a distance between a print medium and an ejection port surface (paper-distance) and change of a conveying amount of a print medium.

Accordingly, a method to generate printing data by multi-pass printing is desired in which even if such a printing position shift occurs between groups of dots, the printing position shift does not cause a significant density reduction. In this specification, resistance to a printing position shift that can maintain a state in which density reduction, furthermore, density unevenness is less visible even if a printing position shift between dot groups occurs due to any factor, will be referred to as “robustness”.

Japanese Patent Application Laid-Open No. 2000-103088 discloses a method to increase robustness and reduce density unevenness. This patent literature focuses attention on that density unevenness or density variation due to a printing position shift between printing scans as described above is caused by that the respective dot groups printed by respective multiple scans have a complete complementary relationship to one another. Then, multiple-valued image data is divided before being converted to binary data, and each of the divided multi-valued printing data is independently (noncorrelatedly) binarized thereby to generate a plurality of dot groups that do not have a complementary relationship to one another. As a result, printing data is generated in which in some regions a plurality of dots are printed on top of each other by multiple printing scans. In such a state, if a printing position shift occurs, two dots to be printed at adjacent positions are printed on top of each other in some regions, and two dots to be printed on top of each other are printed separately in some regions. As a result, reduction and increase of a coverage of dots relative to a print medium is canceled each other, making density reduction less problematic as a whole image, that is, being able to output an image with a higher robustness, compared with the case where a plurality of dot groups have a complementary relationship.

However, the method disclosed in Japanese Patent Application Laid-Open No. 2000-103088 is effective when an image such as a photograph and graphic in which uniformity is important is printed, but may be more problematic when an image such as a character and ruled line in which sharpness and a high density are important. Specifically, when printing is performed in the method disclosed in Japanese Patent Application Laid-Open No. 2000-103088 in which a plurality of dot groups do not previously have a complementary relationship, an image has a region where no dots are printed, and therefore a sufficient coverage cannot be obtained. As a result, an expected sharpness and density in a character and ruled line may not be obtained. In this way, it is difficult to realize an image output that fulfills both of sharpness and robustness of an image.

### SUMMARY OF THE INVENTION

The present invention was made in order to solve the above problems. Therefore, an objective of the present invention is to provide an image processing apparatus, image printing apparatus and image processing method that can output an image fulfilling both of sharpness and robustness by multi-pass printing, regardless of the image.

In a first aspect of the present invention, there is provided an image processing apparatus for an printing apparatus, the printing apparatus performing multiple scans of a print head that ejects ink according to printing data on a same image region thereby to print an image on the same image region, the image processing apparatus comprising: an acquisition unit configured to acquire attribute information of each pixel included in the same image region; a distribution unit configured to distribute a gradation value of the multi-valued data that the each pixel has according to distribution coefficients for the each pixel set based on the acquired attribute information to generate a plurality of multi-valued data, each corresponding to each of the multiple scans; and a gradation level lowering unit configured to lower a number of level of a gradation of each of the plurality of multi-valued density data thereby to generate a plurality of the printing data, each corresponding to each of the multiple scans.

In a second aspect of the present invention, there is provided an image processing method for a printing apparatus, the printing apparatus performing multiple scans of a print head that ejects ink according to printing data on a same image region thereby to print an image on the same image region, the image processing method comprising: an acquisition step to acquire attribute information for each pixel included in the same image region; a distribution step to distribute a gradation value of the multi-valued data that the each pixel has according to distribution coefficients for the each pixel set based on the acquired attribute information to generate a plurality of multi-valued data, each corresponding to each of the multiple scans; and a gradation level lowering step to lower a number of level of a gradation of each of the plurality of multi-valued density data thereby to generate a plurality of the printing data, each corresponding to each of the multiple scans.

In a third aspect of the present invention, there is provided an storage medium that stores a program, by being read by a computer, to have the computer function as an image processing apparatus for a printing apparatus, the printing apparatus performing multiple scans of a print head that ejects ink according to printing data on a same image region thereby to print an image on the same image region, the function comprising: an acquisition unit configured to acquire attribute information of each pixel included in the same image region; a distribution unit configured to distribute a gradation value of the multi-valued data that the each pixel has according to distribution coefficients for the each pixel set based on the acquired attribute information to generate a plurality of multi-valued data, each corresponding to each of the multiple scans; and a gradation level lowering unit configured to lower a number of level of a gradation of each of the plurality of multi-valued density data thereby to generate a plurality of the printing data, each corresponding to each of the multiple scans.

Further features of the present invention will become apparent from the following description of exemplary embodiments (with reference to the attached drawings).

### BRIEF DESCRIPTION OF THE DRAWINGS

FIG. 1 is a schematic configuration view illustrating a serial inkjet printing apparatus that can be used in the present invention;

FIG. 2 is a block diagram illustrating configuration of control of an inkjet printing apparatus;

FIG. 3 is a block diagram for describing image processing by each function according to a first embodiment;

FIG. 4 is a flow chart for describing processing steps performed by an image data distribution unit;

FIG. 5 is a table showing a distribution coefficient for a non-edge region and a distribution coefficient for an edge region;

FIG. 6 is a diagram illustrating density data of a 2×2 pixel region and attribute information corresponding thereto;

FIG. 7 is a diagram illustrating various data and dot printing states in a non-edge region;

FIG. 8 is a diagram illustrating various data and dot printing states in an edge region;

FIG. 9 is a block diagram for describing image processing by each function according to a second embodiment;

FIG. 10 is a schematic diagram illustrating an example of mask patterns used in the second embodiment; and

FIG. 11 is a diagram illustrating input data and output data in a printing scan data dividing unit.

### DESCRIPTION OF THE EMBODIMENTS

### First Embodiment

Hereinafter, embodiment of the present invention will be described in detail with reference to drawings.

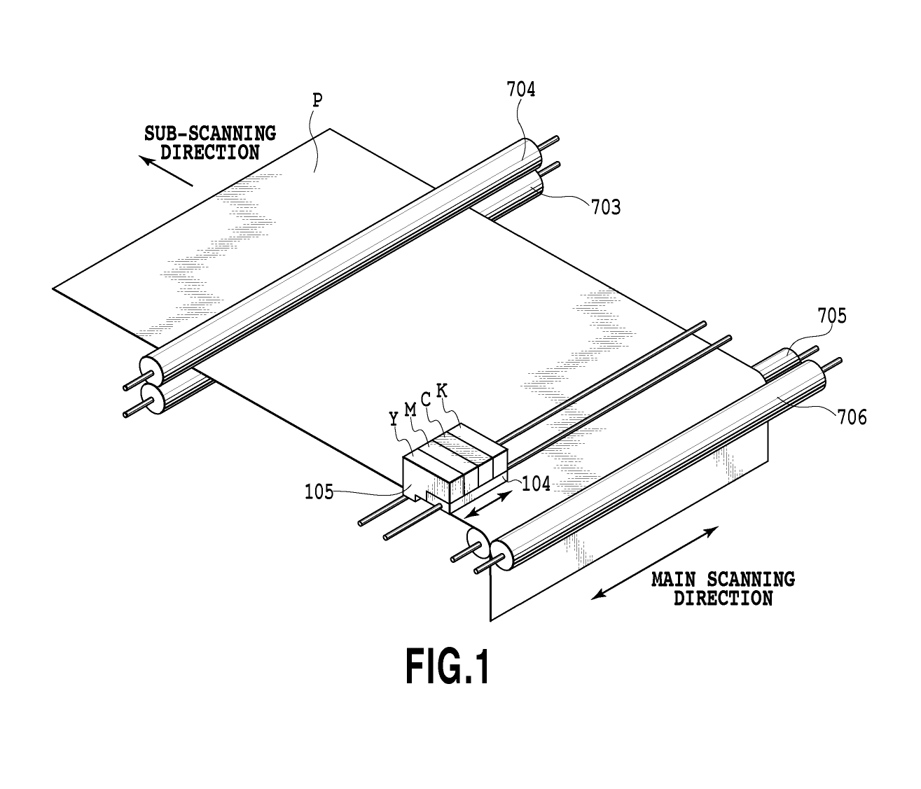

FIG. 1 is a schematic configuration view of a serial-type inkjet printing apparatus (image printing apparatus) that can be used in the present invention. A print head 105 is mounted on a carriage 104 that moves in a main scanning direction at a constant speed and ejects ink according to printing data in a frequency corresponding to the constant speed. After one scan is completed, a conveying roller 703 and auxiliary roller 704 rotate thereby to convey a print medium P held between this roller pair and between a feeding roller 706 and an auxiliary roller 705 by an amount corresponding to the number of multi-passes in a sub-scanning direction. Such a printing scan and conveying operation are intermittently repeated thereby to print an image on the print medium P in a stepwise fashion.

In the print head 105, print heads of black (K), cyan (C), magenta (M) and yellow (Y) colors are arranged in the main scanning direction as illustrated, and the print head of each color has a plurality of ejection ports arranged in the sub-scanning direction.

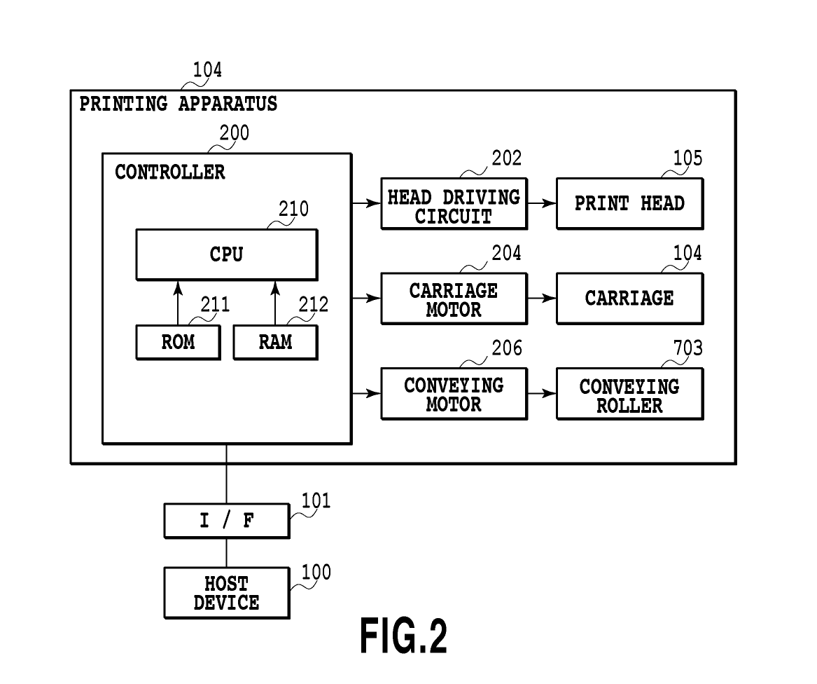

FIG. 2 is a block diagram illustrating configuration of control in the inkjet printing apparatus. A head driving circuit 202 drives the print head 105. A carriage motor 204 makes the carriage 104 on which the print head 105 is mounted reciprocate. A conveying motor 206 drives the conveying roller 703 or feeding roller 706 for conveying a print medium. A controller 200, which controls the whole apparatus, includes: a CPU 210 in the form of a microprocessor; a ROM 211 that stores a control program; and a RAM 212 that is used when the CPU performs image data processing. The ROM 211 stores a program, a distribution coefficient that will be described later, a mask pattern and the like that are used for performing image processing of the present embodiment.

When image data is acquired via an interface (I/F) 101 from a host device 100, the controller 200 subjects the inputted image data to image processing according to the program stored in the ROM 211 and generates printing data corresponding to each scan of multi-pass printing. The controller 200 also controls the head driving circuit 202, carriage motor 204 and conveying motor 206 to perform printing operation according to the generated printing data.

In the present embodiment, the inkjet printing apparatus described with reference to FIGS. 1 and 2 is used to perform multi-pass printing of four-passes in which an image for the same image region is completed by four printing scans (hereinafter also referred to as pass). Hereinafter, image processing for multi-pass printing of four-passes of the present embodiment will be described.

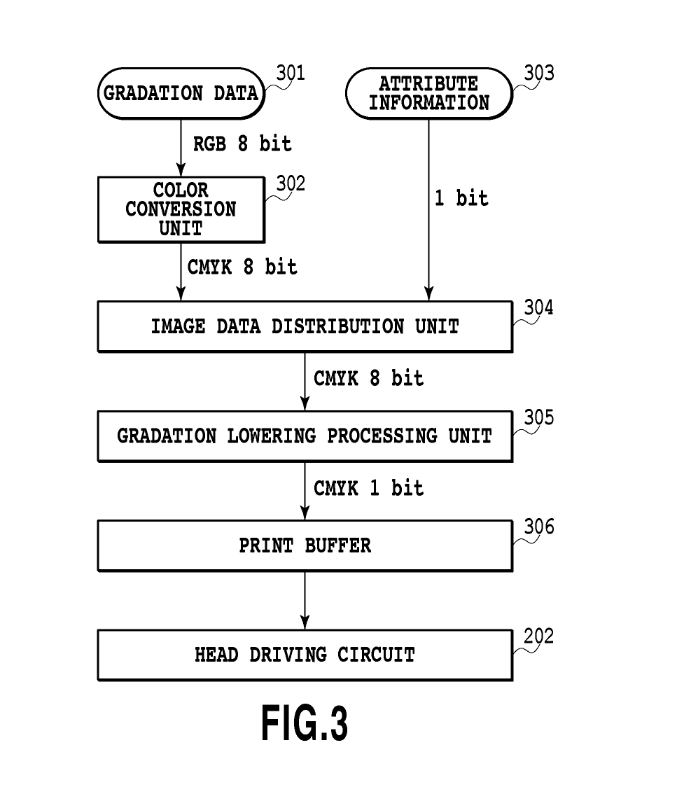

FIG. 3 is a block diagram for describing image processing performed by the CPU 210 by each function. In the present embodiment, image data acquired via the interface (I/F) 101 and temporarily stored in the RAM 212 is composed in a resolution of 600 dpi, and each pixel has a RGB gradation data (8 bits) 301 and attribute information (1 bit) 303.

Of these, the gradation data 301 is sent to a color conversion unit 302, where the gradation data 301 is converted to density data of 256 gradations (8 bits) corresponding to ink colors to be used in the printing apparatus, that is, CMYK colors. Meanwhile, the attribute information 303 is one-bit binary information indicating whether (1) a pixel is located in an edge portion of an image or (2) located in a non-edge portion of the image. The density data after color conversion and the attribute information 303 are transferred to an image data distribution unit 304, where a gradation value of the multi-valued density data is distributed according to the number of multi-passes and attribute information.

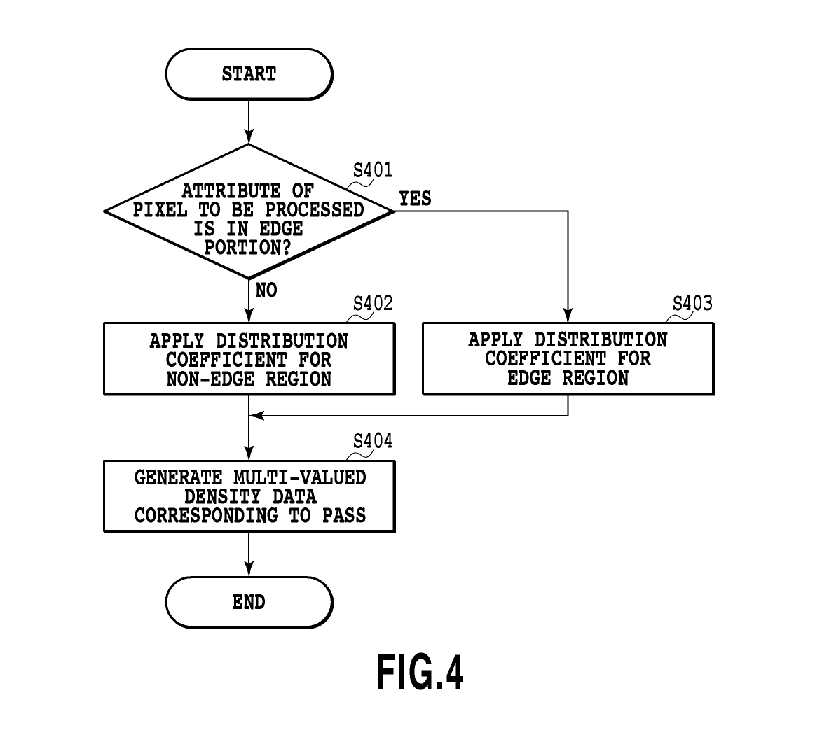

FIG. 4 is a flow chart for describing processing steps performed by the image data distribution unit 304. First, at Step S401, it is determined whether attribute information of a pixel of interest is 0 or 1. If the attribute information is zero, that is, if the pixel of interest is located in a non-edge region, processing proceeds to Step S402, where a distribution coefficient for a non-edge region is set. Meanwhile, if the attribute information is 1, that is, the pixel of interest is located in an edge region, processing proceeds to Step S403, where a distribution coefficient for an edge region is set. After that, at Step S404, according to the distribution coefficient set at Step S402 or Step S403, each of the CMYK density data is distributed to four passes. This generates four multi-valued density data, each corresponding to each pass, and then, this processing is terminated.

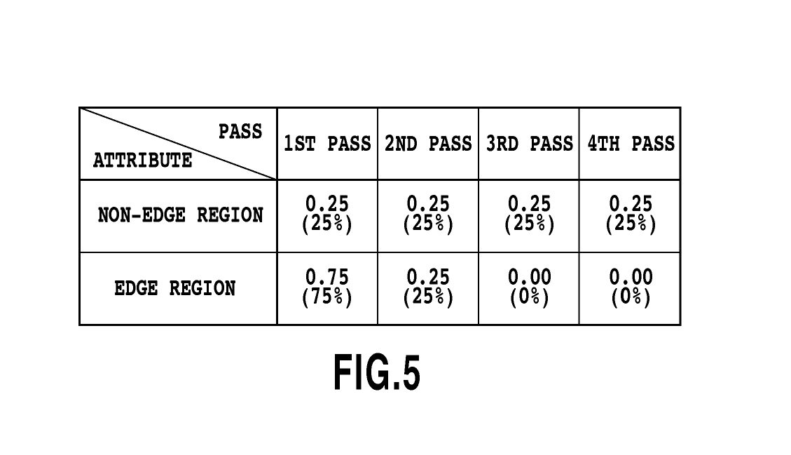

FIG. 5 is a table showing a distribution coefficient for a non-edge region set at Step S402 and a distribution coefficient for an edge region set at Step S403. In a non-edge region, a distribution coefficient is 0.25 for all of four passes. This distributes density data to each of the passes by 25%. For example, if cyan density data outputted from the color conversion unit 302 is 200 and the attribute information is 0, cyan multi-valued density data is generated at Step S404 in such a way that of the cyan multi-valued density data corresponds to each of the first to four passes.

Meanwhile, in an edge region, a distribution coefficient of the first pass is 0.75, a distribution coefficient of the second pass is 0.25, and a distribution coefficient of the third and fourth passes is 0. This distributes 75% of density data to the first pass, 25% to the second pass, and 0% to the third and fourth passes. For example, if cyan density data outputted from the color conversion unit 302 is 200 and the attribute information is 1, cyan multi-valued density data is generated at Step S404 in such a way that 150 for the first pass, 50 for the second pass and 0 for the third and fourth passes are generated respectively. In this way, in the present embodiment, the distribution coefficients are set such that a bias of distribution coefficients in the case where a pixel to be processed is located in an edge region is larger than that in the case where a pixel to be processed is located in a non-edge region.

FIG. 3 will be referred again. The multi-valued density data generated in the image data distribution unit 304, each corresponds to each of four passes, is inputted into a gradation lowering processing unit 305, where the multi-valued density data is subjected to gradation lowering processing for each ink color and for each pass. In the present embodiment, the gradation lowering processing unit 305 employs a well-known error diffusion processing thereby to convert the multi-valued density data that is composed of 8 bits and 256 gradations and corresponds to each color and each pass to printing data that is composed of one bit and two gradations (1 or 0) and corresponds to each color and each pass. Then, 4 colors×4 passes=16 pieces of printing data outputted from the gradation lowering processing unit 305 is temporarily stored in a print buffer 306 disposed in the RAM 212.

When a predetermined amount of printing data has accumulated in the print buffer 306, the printing data is sent to the head driving circuit 202, and the print head 105 performs ejection operation.

Hereinafter, how actual density data is converted by the above image processing will be specifically described with reference to drawings.

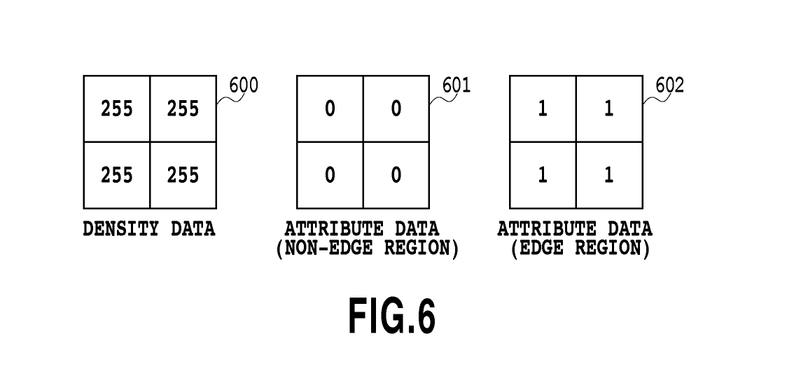

FIG. 6 is a diagram illustrating a concrete example of density data of a 2×2 pixel region outputted from the color conversion processing unit 302 and attribute information of respective pixels corresponding to the region. In FIG. 6, the number of all density data included in the 2×2 pixel region is 255; attribute information 601 illustrates a case where all pixels of the region are located in a non-edge region; and attribute information 602 illustrates a case where all pixels of the region are located in an edge region. Density data 600 is distributed into multi-valued density data of the first to fourth passes according to the distribution coefficients shown in FIG. 5.

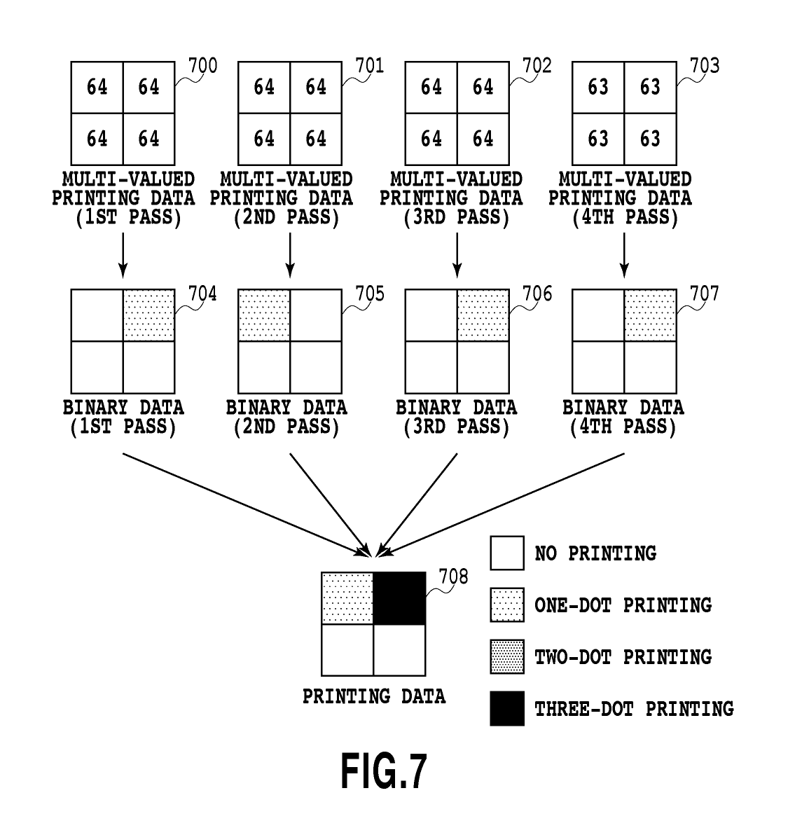

FIG. 7 is a diagram illustrating multi-valued density data and binary printing data of the first to fourth passes, and a dot printing state on a print medium in the case where a 2×2 pixel region is in a non-edge region (attribute information 601). If 2×2 pixel region is in a non-edge region, density data (255) is distributed into multi-valued density data (64, 64, 64, 63) that are roughly even, as illustrated in 700 to 703. After that, error diffusion processing by the gradation lowering processing unit 305 converts the multi-valued density data (64, 64, 64, 63) into binary printing data as illustrated in 704 to 707. In FIG. 7, a marked pixel is a pixel (1) where a dot is printed by the pass, and a white pixel is a pixel (0) where a dot is not printed by the pass. In the present embodiment, error diffusion processing with the use of a different diffusion coefficient is non-correlatedly (independently) performed for each pass. Therefore, results of binary data are non-correlated to one another among four passes: in some pixels like the upper right pixel, dots are printed by a plurality of passes; in some pixels such as an upper left pixel, dots are printed by only one pass; and in some pixels such as lower right and lower left pixels, no dots are printed by any of passes. Printing is performed according to printing data of these four passes; as a result, a dot pattern 708 is printed in a 2×2 pixel region on a print medium. In this case, three dots are printed on top of one another in the upper right pixel by the first, third and fourth passes; one dot is printed in the upper left pixel by the second pass; and no dots are printed in the lower right and lower left pixels by any of the passes. When density data distributed according to distribution coefficients of such small bias is subjected to error diffusion processing non-correlatedly among respective passes, an image with a higher dot overlapping rate and a lower complementary rate is printed.

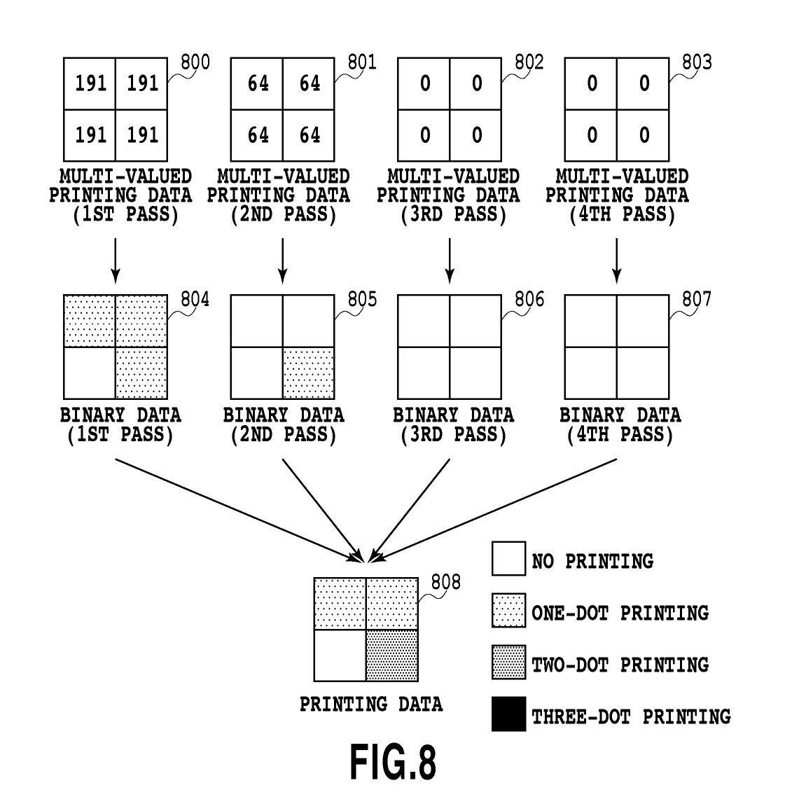

FIG. 8 is a diagram illustrating multi-valued density data and binary printing data of the first to fourth passes, and a dot printing state on a print medium in the case where a 2×2 pixel region is in an edge region (attribute information 602). If a 2×2 pixel region is in an edge region, the density data (255) is distributed to multi-valued density data (191, 64, 0, 0) as illustrated in 800 to 803. After that, error diffusion processing by the gradation lowering processing unit 305 converts the multi-valued density data to binary printing data as illustrated in 804 to 807. In the present embodiment, results of binary data of the respective four passes are not correlated. However, here, since a bias of the distribution coefficients is large, much of multi-valued density data is distributed into the first pass, and then, an image is virtually printed by two-pass printing. As a result, dots are printed by the first and second passes only in a lower right pixel, and only one dot is printed by the first pass in each of other pixels. With respect to density data distributed according to distribution coefficients of such large bias, even if error diffusion processing is non-correlatedly performed for each pass, an image with a lower dot overlapping rate and a higher complementary rate is printed.

Comparing FIG. 7 and FIG. 8, in both of the Figs., four dots are printed in a 2×2 pixel region. However, pattern 708 in FIG. 7 has a higher dot overlapping rate and a lower complementary rate, i.e., a lower dot coverage; and pattern 808 in FIG. 8 has a lower dot overlapping rate and a higher complementary rate, i.e., a higher dot coverage and is virtually printed by two-pass printing. Therefore, a defect due to variations among nozzles tends to appear in pattern 808 than in pattern 708, and there is concern about density unevenness in a halftone image in which uniformity is important. However, since in an image such as a character and ruled line, absolute density and sharpness are more important than uniformity, pattern 808, which is printed by a fewer number of passes and has a higher coverage, is more preferable. Meanwhile, since a multi-pass effect by four-pass printing can be sufficiently obtained in pattern 708, a defect due to variations among nozzles is unlikely to appear. Even if a printing position shift occurs by any of passes, a significant change of coverage does not occur because of separation of overlapping dots and overlapping of separated dots. Therefore, in a halftone image in which uniformity is important, output of the image without density unevenness and with excellent robustness can be expected.

As described above, in the present embodiment, attribute information is managed with image data, the attribute information indicating whether each pixel is included in an edge region in which density and sharpness is more important than uniformity or in a non-edge region in which uniformity is more important than density and sharpness. Then, if an image attribute indicates a non-edge region, less biased distribution coefficients are used to generate multi-valued density data almost evenly for each pass, which is subjected to binarization processing thereby to output an image with a relatively higher dot overlapping rate. Meanwhile, if an image attribute indicates an edge region, widely biased distribution coefficients are used to generate multi-valued density data for each pass, which is subjected to binarization processing thereby to output an image with a lower dot overlapping rate. This enables an image that fulfills both of sharpness and robustness to be outputted by multi-pass printing of four-passes.

### Second Embodiment

Also in the present embodiment, the inkjet printing apparatus described in FIGS. 1 and 2 is used to perform multi-pass (four-pass) printing.

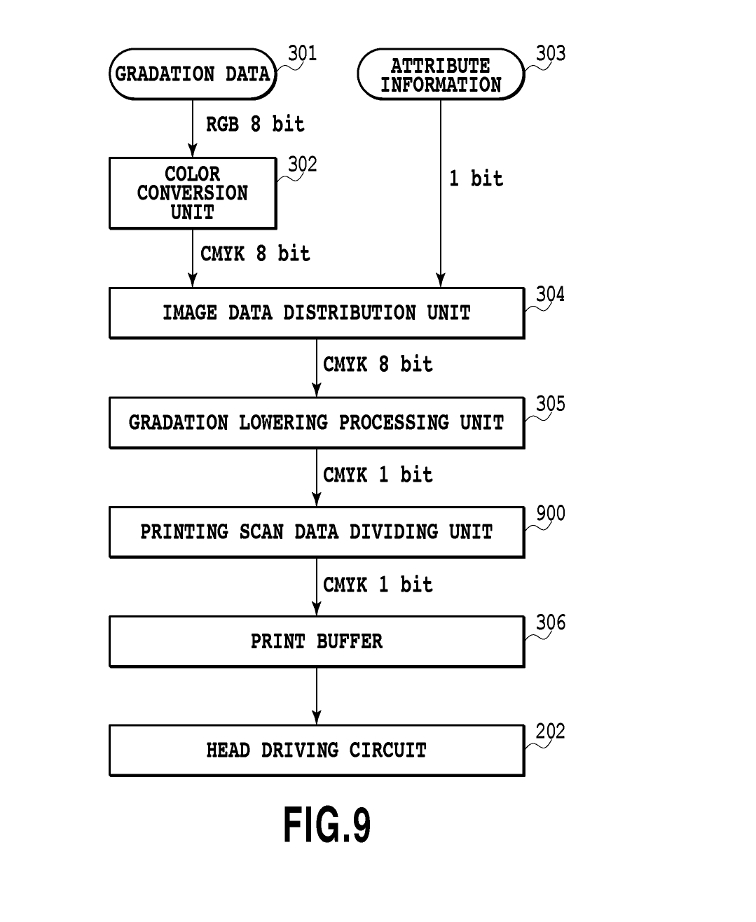

FIG. 9 is a block diagram for describing image processing performed by the CPU 210 in the present embodiment by each function. The present embodiment is different from the first embodiment in that a printing scan data dividing unit 900 is provided after the gradation lowering processing unit 305. In the printing scan data dividing unit 900 according to the present embodiment, of image data distributed by the image data distribution unit 304, only a pixel whose attribute information is “1”, i.e., only a pixel in an edge region is subjected to further division of printing data with the use of mask patterns, which will be specifically described.

Also in the present embodiment, printing data outputted from the gradation lowering processing unit 305 is like binary printing data 704 to 707 if the pixel is in a non-edge region, and is like binary printing data 804 to 807 if the pixel is in an edge region. Then, these printing data is inputted into the printing scan data dividing unit 900.

With respect to a pixel whose attribute information is “0”, the printing scan data dividing unit 900 in the present embodiment lets data through without being divided and sets binary printing data assigned to each pass. With respect to a pixel whose attribute information is “1”, the printing scan data dividing unit 900 lets binary printing data 805 assigned to the second pass thorough without being divided and sets binary printing data for the second pass, but divides binary printing data 804 assigned to the first pass into three with the use of previously provided mask patterns.

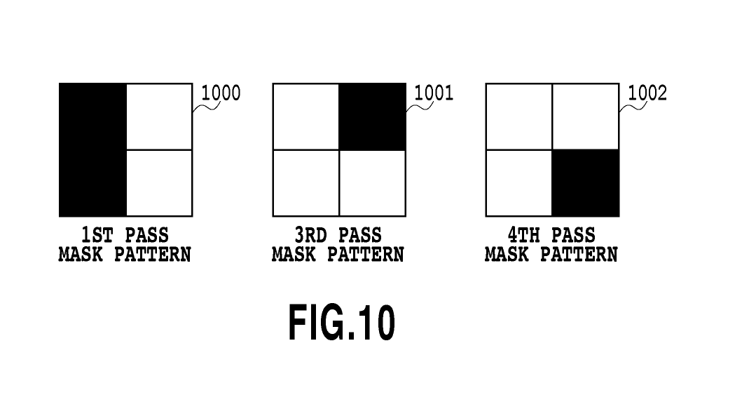

FIG. 10 is a schematic diagram illustrating an example of mask patterns to be used by the printing scan data dividing unit 900 according to the present embodiment. In FIG. 10, 1000 is a mask pattern for generating binary printing data for the first pass; 1001 is a mask pattern for generating binary printing data for the third pass; and 1002 is a mask pattern for generating binary printing data for the fourth pass. FIG. 10 illustrates a 2×2 pixel region; a pixel indicated by black is a pixel (1) that is printed by the pass; a pixel indicated by white is a pixel (0) that is not printed by the pass. Logical multiplication (AND operation) is performed between each mask pattern and binary printing data 804 thereby to decide binary printing data assigned to each printing scan. Mask patterns 1000 to 1002 have a complementary relationship to one another, and a pixel that is set to be printed (1) by the binary printing data 804 is printed by any of the first, third or fourth passes.

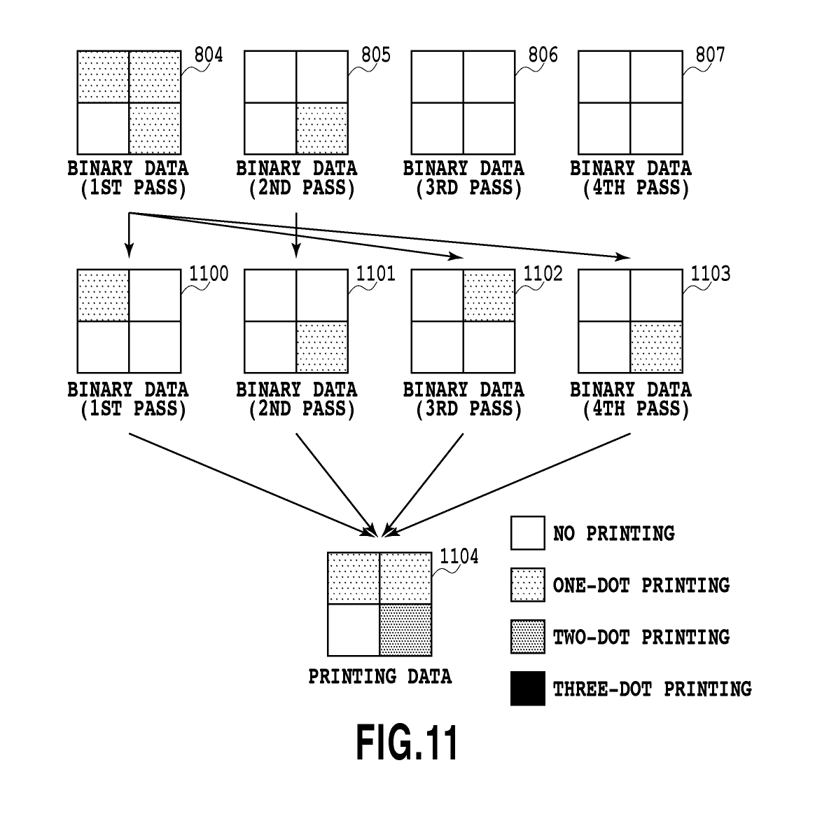

FIG. 11 is a diagram illustrating inputted binary printing data and outputted binary printing data in the printing scan data dividing unit 900. The mask patterns 1000 to 1002 illustrated in FIG. 10 are used to divide binary printing data 804 into three binary printing data 1100, 1102 and 1103. Binary printing data 1101, which is already assigned to the second pass in the gradation lowering processing unit 305 and passes through the printing data dividing unit 900 without being processed, is added to the three binary printing data 1100, 1102 and 1103 thereby to generate binary printing data 1100 to 1103. The binary printing data 1100 to 1103, each corresponding to each pass of actual multi-pass printing of four-passes, are transferred to the print buffer 306. As a result, a dot printing state 1104 on a print medium is the same as the printing state 808 illustrated in FIG. 8.

In the present embodiment, by using such a printing data dividing unit 900, even if biased distribution coefficients are used to distribute multi-valued density data, the actual number of multi-passes can be four passes, not two passes as the first embodiment. As a result, even in an edge region, a multi-pass effect of four-pass printing can be sufficiently obtained, and a defect due to variations among nozzles can be more unlikely to occur than the first embodiment.

### Other Embodiments

Two embodiments have been described above, but the present invention is not limited to these embodiments and can be implemented without departing from the principle of the present invention. For example, the number of bits of image data corresponding to ink colors and multi-valued density data has been exemplified as 8 bits (256 gradations), but the bit number (gradation number) is not limited to this.

The gradation lowering processing unit 305 in the above embodiments is configured to convert (binarize) multi-valued density data into binary data, but the present invention is not limited to such a configuration. Any gradation lowering processing unit may be employed as long as the gradation lowering processing unit can quantize inputted multi-valued data into smaller number of gradations. Data outputted from the gradation lowering processing unit may be N values (N is an integer greater or equal to 2) such as three and four values, as long as, after the gradation lowering processing is performed, processing to further convert N-value data into binary data, for example, by using a predetermined dot pattern is provided.

In the above embodiment, attribute information is used in order to divide into an edge portion and a non-edge portion, but attribute information of the present invention is not limited to such division. Any division can be employed, such as a character region and other region, and a ruled line region and other region, as long as the division is used to properly divide a region into a region in which sharpness is important and a region in which density unevenness (robustness) is important.

In addition, the above embodiments have been described taking four-pass printing as an example of multi-pass printing, but a printing apparatus according to the present invention can employ the more number of passes and the less number of passes. For example, in the case of eight-pass printing, the image data distribution unit may distribute multi-valued density data to eight data corresponding to eight passes; and in the case of 2-pass printing, the image data distribution unit may distribute multi-valued density data to two data corresponding to two passes. In doing so, needless to say, a distribution coefficient is changed according to the number of multi-passes. However, a distribution coefficient is not limited to a value shown in FIG. 5 even if the same four-pass printing. Even in the same number of multi-passes, a degree of importance of sharpness and robustness and a degree of visibility may vary depending on a type of a print medium and a type of an image (such as a text or a photograph). In such a case, it is effective to provide different distribution coefficients according to various conditions such as a type of a print medium and a type of an outputted image.

Mask patterns described in the second embodiment are not limited to the patterns illustrated in FIG. 10. The number of divisions by mask patterns varies depending on the number of multi-passes and a degree of variation of distribution coefficients. In the second embodiment, mask patterns for dividing into three printing scans is exemplified, but a plurality of mask patterns for dividing into other multiple printing scans, such as two printing scans and four printing scans can be provided.

In the embodiments described above, image processing according to the present invention illustrated in FIGS. 3 and 9 is configured to be performed in a printing apparatus. The present invention is not limited to such a configuration. The image processing according to the present invention can be performed in a host device, such as a personal computer, connected to the external of the printing apparatus. In this case, a system composed of the printing apparatus and a host device is the image processing apparatus of the present invention.

The present invention can be realized by a program code that realizes a function of the above embodiments or a storage medium that stores the program code. Also, a program code stored in a storage medium is read by a system or a computer of (or CPU or MPU) a device and performed thereby to achieve the present invention. In this case, the program code itself read out from the storage medium realizes the above embodiment, and the storage medium that stores the program code configures the present invention.

As a storage medium to supply a program code, a floppy (Registered Trademark) disk, hard disk, optical disk, magnetic optical disk, CD-ROM, CD-R, electromagnetic tape, nonvolatile memory card and ROM can be used, for example.

By performing a program code read out by a computer, a function of the above embodiments is realized and also the OS running on the computer may perform part or all of actual processing according to the program code.

Further, after a program code is written on a memory provided in a function expansion board inserted into a computer and a function expansion unit connected to a computer, a CPU or the like may part or all of actual processing according to an instruction of the program code.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2011-127232, filed Jun. 7, 2011, which is hereby incorporated by reference herein in its entirety.

What is claimed is:

1. An image processing apparatus for an printing apparatus, the printing apparatus performing multiple scans of a print head that ejects ink according to printing data on a same image region thereby to print an image on the same image region, the image processing apparatus comprising:
an acquisition unit configured to acquire attribute information of each pixel included in the same image region;
a distribution unit configured to distribute a gradation value of the multi-valued data that the each pixel has according to distribution coefficients for the each pixel set based on the acquired attribute information to generate a plurality of multi-valued data, each corresponding to each of the multiple scans; and
a gradation level lowering unit configured to lower a number of level of a gradation of each of the plurality of multi-valued density data thereby to generate a plurality of the printing data, each corresponding to each of the multiple scans.

2. The image processing apparatus according to claim 1, further comprising a unit to divide printing data whose value is not 0, of the plurality of printing data generated by the gradation lowering unit each corresponding to each of the multiple scans, into printing data of other scans whose value is 0 of the multiple scans.

3. The image processing apparatus according to claim 1 wherein the attribute information indicates whether the pixel is included in an edge region or a non-edge region of an image, and the distribution coefficients for each pixel is set such that a bias of distribution coefficients in the case where the attribute information indicates that the pixel is included in the edge region is larger than a bias of distribution coefficients in the case where the attribute information indicates that the pixel is included in the non-edge region.

4. The image processing apparatus according to claim 1 wherein the attribute information indicates whether the pixel is included in a character or ruled line region or not included in a character or ruled line region, and the setting unit sets a distribution coefficient for each pixel such that a bias of distribution coefficients in the case where the attribute information indicates that the pixel is included in the character or ruled line region is larger than a bias of distribution coefficients in the case where the attribute information indicates that the pixel is not included in the character or ruled line region.

5. An image processing method for a printing apparatus, the printing apparatus performing multiple scans of a print head that ejects ink according to printing data on a same image region thereby to print an image on the same image region, the image processing method comprising:
an acquisition step to acquire attribute information for each pixel included in the same image region;
a distribution step to distribute a gradation value of the multi-valued data that the each pixel has according to distribution coefficients for the each pixel set based on the acquired attribute information to generate a plurality of multi-valued data, each corresponding to each of the multiple scans; and
a gradation level lowering step to lower a number of level of a gradation of each of the plurality of multi-valued density data thereby to generate a plurality of the printing data, each corresponding to each of the multiple scans.

6. The image processing method according to claim 5, further comprising a step to divide printing data whose value is not 0, of the plurality of printing data generated by the gradation lowering step each corresponding to each of the multiple scans, into printing data of other scans whose value is 0 of the multiple scans.

7. The image processing method according to claim 5 wherein the attribute information indicates whether the pixel is included in an edge region or a non-edge region of an image, and the distribution coefficient for each pixel is set such that a bias of distribution coefficients in the case where the attribute information indicates that the pixel is included in the edge region is larger than a bias of distribution coefficients in the case where the attribute information indicates that the pixel is included in the non-edge region.

8. The image processing method according to claim 5 wherein the attribute information indicates whether the pixel is included in a character or ruled line region or not included in a character or ruled line region, and the setting step sets a distribution coefficient for each pixel such that a bias of distribution coefficients in the case where the attribute information indicates that the pixel is included in the character or ruled line region is larger than a bias of distribution coefficients in the case where the attribute information indicates that the pixel is not included in the character or ruled line region.

9. A storage medium that stores a program, by being read by a computer, to have the computer function as an image processing apparatus for a printing apparatus, the printing apparatus performing multiple scans of a print head that ejects ink according to printing data on a same image region thereby to print an image on the same image region, the function comprising:
an acquisition unit configured to acquire attribute information of each pixel included in the same image region;
a distribution unit configured to distribute a gradation value of the multi-valued data that the each pixel has according to distribution coefficients for the each pixel set based on the acquired attribute information to generate a plurality of multi-valued data, each corresponding to each of the multiple scans; and
a gradation level lowering unit configured to lower a number of level of a gradation of each of the plurality of multi-valued density data thereby to generate a plurality of the printing data, each corresponding to each of the multiple scans.
